(19) United States
(12) Patent Application Publication
(10) Pub. No.: US 2010/0067472 A1
(43) Pub. Date: Mar. 18, 2010

(54) Backward compatible physical uplink control channel resource mapping

(75) Inventors: Carsten Ball, Munchen (DE); Sabine Roessel, Munchen (DE); Esa Tiirola, Kemplele (FI); Kari Hooli, Oulu (FI); Kari Pajukoski, Oulu (FI); Mikko Pesola, Marynummi (FI)

Correspondence Address: HARRINGTON & SMITH, 4 RESEARCH DRIVE, Suite 202, SHELTON, CT, 06484-6212, US

(73) Assignees: Nokia Siemens Networks Oy; Nokia Corporation

(21) Appl. No.: 12/583,095

(22) Filed: Aug. 14, 2009

Related U.S. Application Data
(60) Provisional application No. 61/189,033, filed on Aug. 15, 2008.

(51) Int. Cl. H04W 72/00

(52) U.S. Cl. 370/329

(57) ABSTRACT

A method for uplink signaling is described. The method includes determining one or more macro-configuration parameters. The one or more macro-configuration parameters define a resource allocation mapping for a control channel. A set of parameters including one or more micro-configuration parameters and the one or more macro-configuration parameters are generated. A transmission of the set of parameters to one or more user equipment is caused to be sent. Apparatus and computer readable media are also described.

### CROSS-REFERENCE TO RELATED APPLICATIONS

This patent application claims priority under 35 U.S.C. §119(e) from U.S. Provisional Patent Application No. 61/189,033, filed Aug. 15, 2008, the disclosure of which is incorporated by reference herein in its entirety.

### TECHNICAL FIELD

The exemplary and non-limiting embodiments of this invention relate generally to wireless communication systems, methods, devices and computer program products and, more specifically, relate to techniques for uplink signaling between user equipment and a network access node.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Various abbreviations that appear in the specification and/or in the drawing figures are defined as follows:
3GPP third generation partnership project
ACK acknowledgement
ACLR adjacent channel leakage ratio
CDM code division multiplexing
CM cubic metric
CQI channel quality indicator
DL downlink (eNB towards UE)
eNB E-UTRAN Node B (evolved Node B)
EPC evolved packet core
E-UTRAN evolved UTRAN (LTE)
FDMA frequency division multiple access
HARQ hybrid automatic repeat request
ICIC inter-cell interference coordination
LTE long term evolution
MAC medium access control
MM mobility management
MME mobility management entity
NACK negative ACK
Node B base station
O&M operations and maintenance
OFDMA orthogonal frequency division multiple access
PDCP packet data convergence protocol
PHY physical
PRACH physical random access channel
PRB physical resource block
PUCCH physical uplink control channel
PUSCH physical uplink shared channel
RB resource block
Rel. 8 release 8
RLC radio link control
RRC radio resource control
SC-FDMA single carrier, frequency division multiple access
S-GW serving gateway
SIB system information block
SRI scheduling request indicator
SRS sounding reference signal
TTI transmission time interval
UE user equipment
UL uplink (UE towards eNB)
UTRAN universal terrestrial radio access network
ZAC zero auto-correlation

A communication system known as evolved UTRAN (E-UTRAN, also referred to as UTRAN-LTE or as E-UTRA) is currently under development within the 3GPP. In this system the DL access technique will be OFDMA, and the UL access technique will be SC-FDMA.

One specification of interest to these and other issues related to the invention is 3GPP TS 36.300, V8.3.0 (2007-12), 3rd Generation Partnership Project; Technical Specification Group Radio Access Network; Evolved Universal Terrestrial Radio Access (E-UTRA) and Evolved Universal Terrestrial Access Network (E-UTRAN); Overall description; Stage 2 (Release 8), which is incorporated by reference herein in its entirety.

FIG. 4 reproduces FIG. 4 of 3GPP TS 36.300, and shows the overall architecture of the E-UTRAN system. The E-UTRAN system includes eNBs, providing the E-UTRA user plane (PDCP/RLC/MAC/PHY) and control plane (RRC) protocol terminations towards the UE. The eNBs are interconnected with each other by means of an X2 interface. The eNBs are also connected by means of an S1 interface to an EPC, more specifically to a MME (Mobility Management Entity) by means of a S1-MME interface and to a Serving Gateway (S-GW) by means of a S1-U interface. The S1 interface supports a many-to-many relation between MMEs/Serving Gateways and eNBs.

The eNB hosts the following functions:
functions for Radio Resource Management: Radio Bearer Control, Radio Admission Control, Connection Mobility Control, Dynamic allocation of resources to UEs in both uplink and downlink (scheduling);
IP header compression and encryption of user data stream;
selection of a MME at UE attachment;
routing of User Plane data towards Serving Gateway;
scheduling and transmission of paging messages (originated from the MME);
scheduling and transmission of broadcast information (originated from the MME or O&M); and
measurement and measurement reporting configuration for mobility and scheduling.

The PUCCH carries UL control information such as ACK/NACK (A/N), CQI and a Scheduling Request Indicator (SRI). The PUCCH is used in the absence of UL data, and is never transmitted simultaneously with PUSCH in LTE Rel. 8. It has also been decided to support concurrent transmission of PUSCH and PUCCH as an additional mode in LTE-Advanced (i.e., LTE Rel. 10 and beyond). FIG. 1 shows the logical split between different PUCCH formats and how the PUCCH is configured in the LTE specification. Reference can be made to 3GPP TS 36.211 V8.3.0 (2008-05), 3rd Generation Partnership Project; Technical Specification Group Radio Access Network; Evolved Universal Terrestrial Radio Access (E-UTRA); Physical Channels and Modulation (Release 8).

FIG. 1 shows the configuration of the PUCCH.

Different UEs are multiplexed on the PUCCH by means of CDM (i.e., CDM within the same resource block (RB)). Two basic PUCCH formats are supported in LTE Rel. 8 specifications, namely Format 1 and Format 2. Both formats use a cyclic shift of a ZAC sequence in each symbol (CDM in cyclic shift domain). Format 1 also utilizes block-wise spreading on top of the ZAC sequence (CDM using block spreading codes). PUCCH formats are used in the following manner:

Format 1: SRI

Format 1a: 1-bit A/N

Format 1b: 2-bit A/N

Format 2: Periodic CQI

Format 2a: Periodic CQI+1-bit A/N

Format 2b: Periodic CQI+2-bit A/N

The PUCCH is configured using at least one or more of the following parameters (see 3GPP TS 36.211 for a complete list):
N_{RB}^{PUCCH} Number of resource blocks in a slot used for PUCCH transmission (set by higher layers);
N_{RB}⁽²⁾ Bandwidth reserved for PUCCH formats 2/2a/2b, expressed in multiples of N_{sc}^{RB};
N_{cs}⁽¹⁾ Number of cyclic shifts used for PUCCH formats 1/1a/1b in a resource block with a mix of formats 1/1a/1b and 2/2a/2b; and
N_{sc}^{RB} Resource block size in the frequency domain, expressed as a number of subcarriers (=12).

Mapping of logical resource blocks (denoted as m) into physical resource blocks is shown in FIG. 2. Slot-based frequency hopping is always used on PUCCH.

n_{PRB} Physical resource block number (index)

N_{RB}^{UL} Uplink bandwidth configuration, expressed in multiples of (N_{sc}^{RB}=12)

By configuration of the PUCCH reserved resources: available PUSCH resources can be defined (or a PUCCH region for a hopping PUSCH can be defined such that the PUSCH can be scheduled inside the PUCCH region), as well as potential positions of the PRACH.

It has been decided that the sounding reference signal transmission can be semi-statically configured with respect to the repetition factor and the bandwidth.

Based on the current status of the LTE Rel-8 configuration, the uplink bandwidth can be flexibly configured by applying PUCCH blanking as described in commonly owned and copending U.S. Patent Application No. 61/128,341, filed May 21, 2008 by Esa Tiirola, Kari Hooli, Kari Pajukoski and Sabine Rössel, entitled “Deployment Of LTE UL System For Arbitrary System Bandwidths via PUCCH Configuration”.

Simulations conducted within the framework of 3GPP have shown that, due to inter-modulation products of 3^{rd} order (and for some cases of 5^{th} order), PUCCH blanking will be routinely needed in coexistence situations with LTE and/or its further releases. However, as PUCCH blanking is basically a symmetric operation, in some cases additional capability may be needed.

Reference may also be made to 3GPP TSG RAN WG4 (Radio) Meeting #48, Jeju, Korea, 18-20 Aug. 2008, (R4-082027) “Adjacent Channel UL/DL Co-existence”, Motorola. This document proposes re-mapping of the lower PUCCH resources towards higher frequencies in such a way that the re-mapped PUCCH forms a continuous frequency band.

### SUMMARY

The below summary section is intended to be merely exemplary and non-limiting.

The foregoing and other problems are overcome, and other advantages are realized, by the use of the exemplary embodiments of this invention.

In a first aspect thereof the exemplary embodiments of this invention provide a method for uplink signaling. The method includes determining one or more macro-configuration parameters. The one or more macro-configuration parameters define a resource allocation mapping for a control channel. A set of parameters including one or more micro-configuration parameters and the one or more macro-configuration parameters are generated. A transmission of the set of parameters to one or more user equipment is caused to be sent.

In a further aspect thereof the exemplary embodiments of this invention provide an apparatus for uplink signaling. The apparatus includes at least one processor; and at least one memory including computer program code, the at least one memory and the computer program code configured to, with the at least one processor, cause the apparatus to determine one or more macro-configuration parameters. The one or more macro-configuration parameters define a resource allocation mapping for a control channel. The apparatus also generates a set of parameters including one or more micro-configuration parameters and the one or more macro-configuration parameters are included. The apparatus also causes a transmission of the set of parameters to one or more user equipment to be sent.

In an additional aspect thereof the exemplary embodiments of this invention provide a computer readable medium tangibly encoded with a computer program executable by a processor to perform actions for uplink signaling. The actions include determining one or more macro-configuration parameters. The one or more macro-configuration parameters define a resource allocation mapping for a control channel. A set of parameters including one or more micro-configuration parameters and the one or more macro-configuration parameters are generated. A transmission of the set of parameters to one or more user equipment is caused to be sent.

In a further aspect thereof the exemplary embodiments of this invention provide an apparatus for uplink signaling. The apparatus includes means for determining one or more macro-configuration parameters. The one or more macro-configuration parameters define a resource allocation mapping for a control channel. Means for generating a set of parameters including one or more micro-configuration parameters and the one or more macro-configuration parameters are included. The apparatus also includes means for causing a transmission of the set of parameters to one or more user equipment to be sent.

In an additional aspect thereof the exemplary embodiments of this invention provide a method for uplink signaling. The method includes receiving a set of parameters comprising micro-configuration parameters and at least one macro-configuration parameter. The at least one macro-configuration parameter defines a physical uplink control channel and channel resource allocation mapping for a set of resource blocks. A transmission is received. The transmission is configured in accordance with the set of parameters.

In a further aspect thereof the exemplary embodiments of this invention provide an apparatus for uplink signaling. The apparatus includes at least one processor; and at least one memory including computer program code, the at least one memory and the computer program code configured to, with the at least one processor, cause the apparatus to receive a set of parameters comprising micro-configuration parameters and at least one macro-configuration parameter. The at least one macro-configuration parameter defines a physical uplink control channel and channel resource allocation mapping for a set of resource blocks. The apparatus also receives a transmission configured in accordance with the set of parameters.

In an additional aspect thereof the exemplary embodiments of this invention provide a computer readable medium tangibly encoded with a computer program executable by a processor to perform actions for uplink signaling. The actions include receiving a set of parameters comprising micro-configuration parameters and at least one macro-configuration parameter. The at least one macro-configuration parameter defines a physical uplink control channel and channel resource allocation mapping for a set of resource blocks. A transmission configured in accordance with the set of parameters is received.

In a further aspect thereof the exemplary embodiments of this invention provide an apparatus for uplink signaling. The apparatus includes means for receiving a set of parameters comprising micro-configuration parameters and at least one macro-configuration parameter. The at least one macro-configuration parameter defines a physical uplink control channel and channel resource allocation mapping for a set of resource blocks. Means for receiving a transmission configured in accordance with the set of parameters are included.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 shows the configuration of the PUCCH.

FIG. 2 illustrates a mapping to physical resource blocks for the PUCCH as per 3GPP TS 36.211.

FIGS. 3A and 3B, collectively referred to as FIG. 3, show six non-limiting examples of flexible PUCCH configuration in accordance with exemplary embodiments of this invention.

FIG. 4 reproduces FIG. 4 of 3GPP TS 36.300, and shows the overall architecture of the E-UTRAN system.

FIG. 5 shows a simplified block diagram of various electronic devices that are suitable for use in practicing the exemplary embodiments of this invention.

FIG. 6 is a logic flow diagram that illustrates the operation of a method, and a result of execution of computer program instructions, in accordance with various exemplary embodiments of this invention.

FIG. 7 shows a simplified block diagram of various electronic devices that are suitable for use in practicing various exemplary embodiments of this invention.

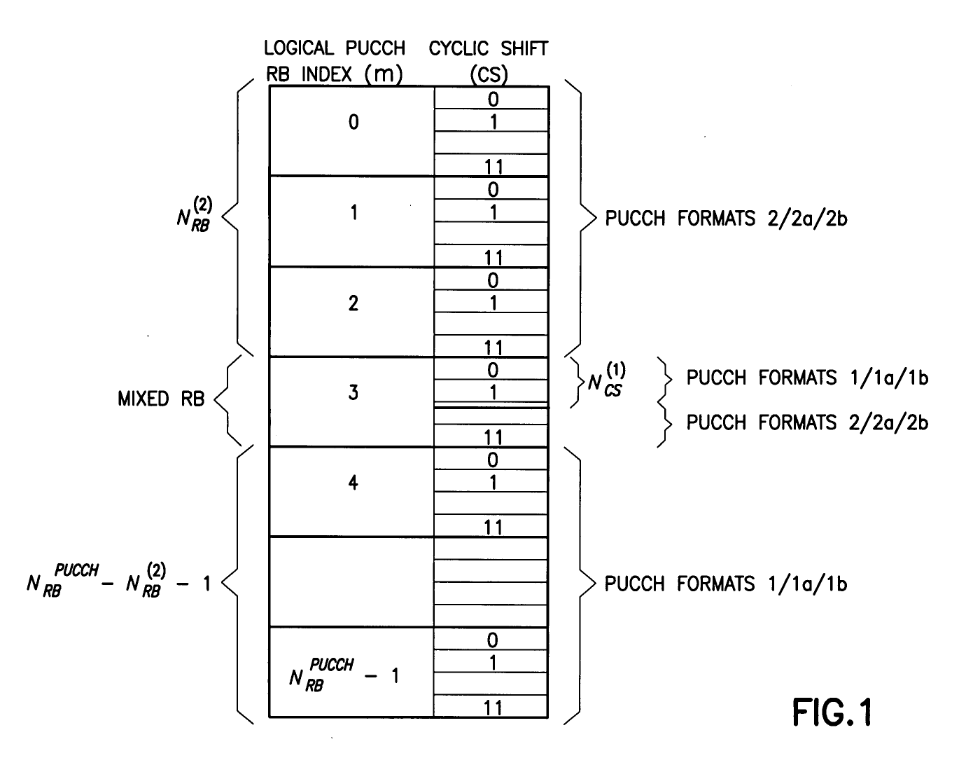

### DETAILED DESCRIPTION

Various exemplary embodiments of this invention relate generally to the UL part of the UTRAN LTE Rel. 8 and its evolution towards further releases (e.g., towards LTE-Advanced or LTE-A). More specifically, various exemplary embodiments consider the configuration of the PUCCH.

Various exemplary embodiments in accordance with this invention define a flexible PUCCH resource mapping scheme for LTE-Advanced (and possibly also LTE Rel-9) which is backward compatible with the current LTE Rel-8 and which supports interference mitigation and UL system bandwidth flexibility for a number of use cases. For example, the flexible PUCCH resource mapping introduces a macro-configuration based on the LTE Rel-8 compliant micro-configuration in order to cover:

coexistence situations where the state of the art results in a data channel PUSCH bandwidth that is excessively fragmented; and

asymmetric coexistence situations where the state of the art results in a data channel PUSCH that is excessively reduced.

A flexible PUCCH resource mapping in accordance with these exemplary embodiments maintains key advantages of the LTE Rel-8 compliant PUCCH micro-configuration including:

frequency diversity exploited via slot-based hopping;

minimized fragmentation of the PUSCH data channel; and

a minimum change to the SRS resource mapping.

The usage of various exemplary embodiments in accordance with this invention also permits transmission of the PUSCH on the lower/higher resource block (RBs) that are made available by the use of the re-arranged PUCCH.

Prior to this invention there were no satisfactory solutions to the problems discussed above.

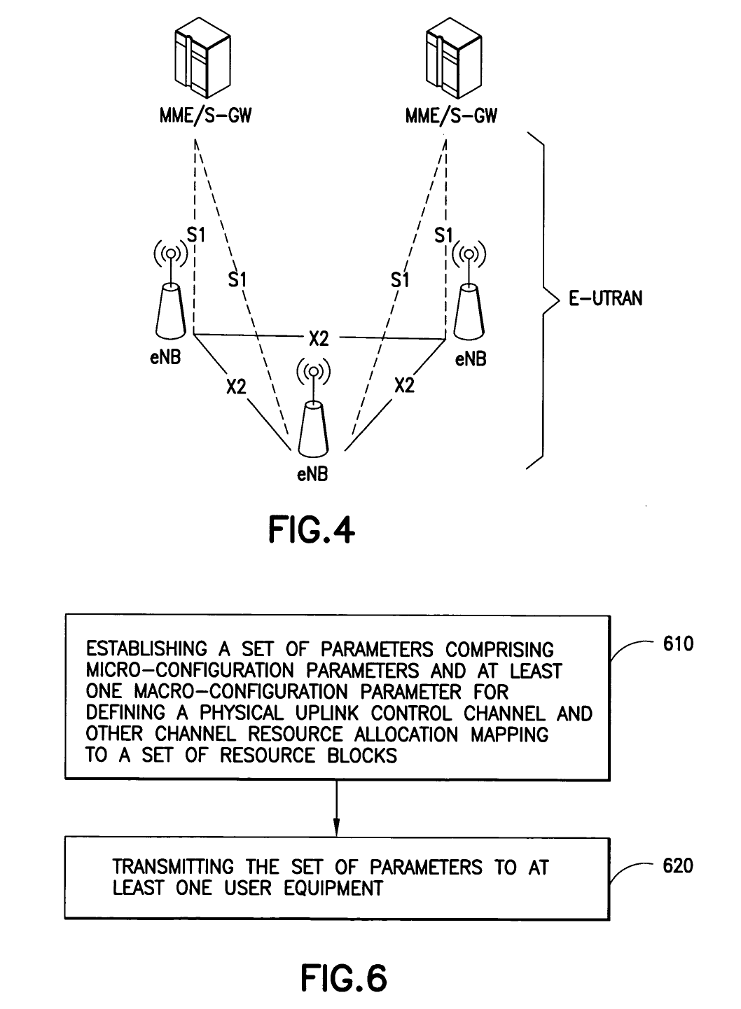

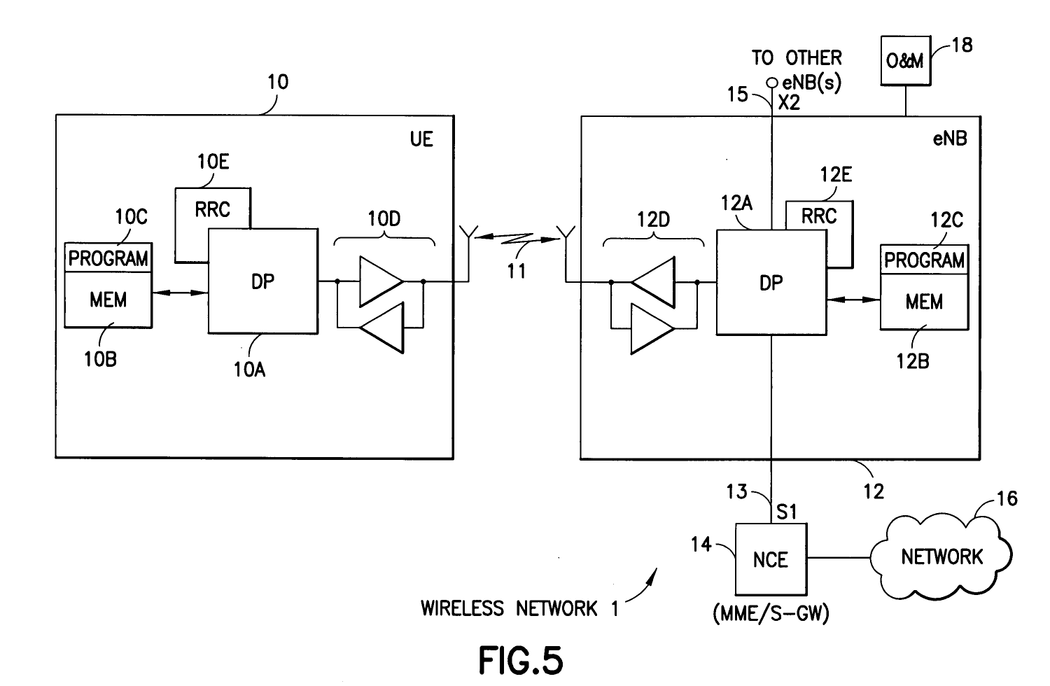

Reference is made first to FIG. 5 for illustrating a simplified block diagram of various electronic devices that are suitable for use in practicing various exemplary embodiments of this invention. In FIG. 5 a wireless network 1 is adapted for communication with an apparatus, such as one that embodies or that is embodied in a mobile communication device (which may be referred to as a UE 10), via a network access node, such as a Node B (base station), and more specifically an eNB 12. The network 1 may include a network control element (NCE) 14 that may include the MME/S-GW functionality shown in FIG. 4, and which provides connectivity with a network 16, such as a telephone network and/or a data communications network (e.g., the interne).

The UE 10 includes a data processor (DP) 10A, a memory (MEM) 10B that stores a program (PROG) 10C, and a suitable radio frequency (RF) transceiver 10D for bidirectional wireless communications 11 with the eNB 12 via one or more antennas. The eNB 12 also includes a DP 12A, a MEM 12B that stores a PROG 12C, and a suitable RF transceiver 12D. The eNB 12 is coupled via a data path 13 to the NCE 14. The data path 13 may be implemented as the S1 interface shown in FIG. 4. At least one of the PROGs 10C and 12C is assumed to include program instructions that, when executed by the associated DP, enable the electronic device to operate in accordance with various exemplary embodiments of this invention, as will be discussed below in greater detail.

That is, various exemplary embodiments of this invention may be implemented at least in part by computer software executable by the DP 10A of the UE 10 and by the DP 12A of the eNB 12, or by hardware, or by a combination of software and hardware.

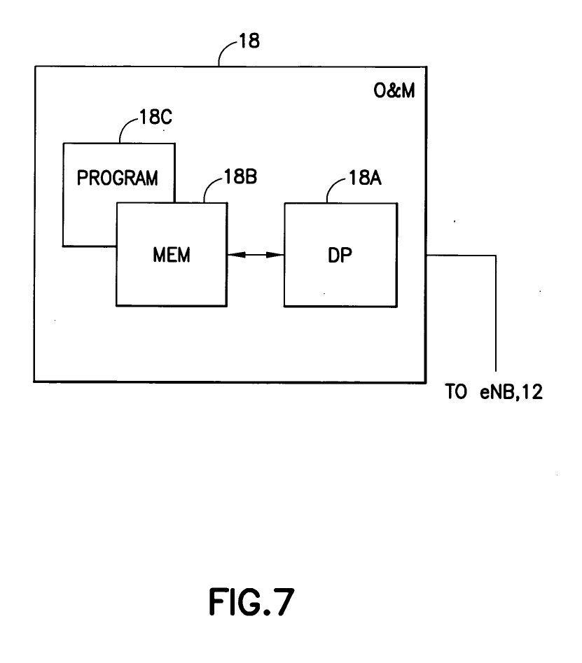

An O&M controller 18 may also be coupled with the eNB 12, and used as discussed below. Shown in FIG. 7, the O&M includes a data processor (DP) 18A and a memory (MEM) 18B that stores at least one program (PROG) 18C. The O&M controller 18 is configured to communicate with at least the eNB 12.

For the purposes of describing various exemplary embodiments of this invention the UE 10 may be assumed to also include a RRC function 10E, and the eNB 12 includes a corresponding RRC function 12E. Signaling of PUCCH parameters between the eNB 12 and the UE 10 may be achieved using RRC signaling, as discussed below.

In general, the various embodiments of the UE 10 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 10B, 12B and 18B may be of any type suitable to the local technical environment and may be implemented using any suitable data storage technology, such as semiconductor based memory devices, flash memory, magnetic memory devices and systems, optical memory devices and systems, fixed memory and removable memory. The DPs 10A, 12A and 18A may be of any type suitable to the local technical environment, and may include one or more of general purpose computers, special purpose computers, microprocessors, digital signal processors (DSPs) and processors based on multi-core processor architectures, as non-limiting examples.

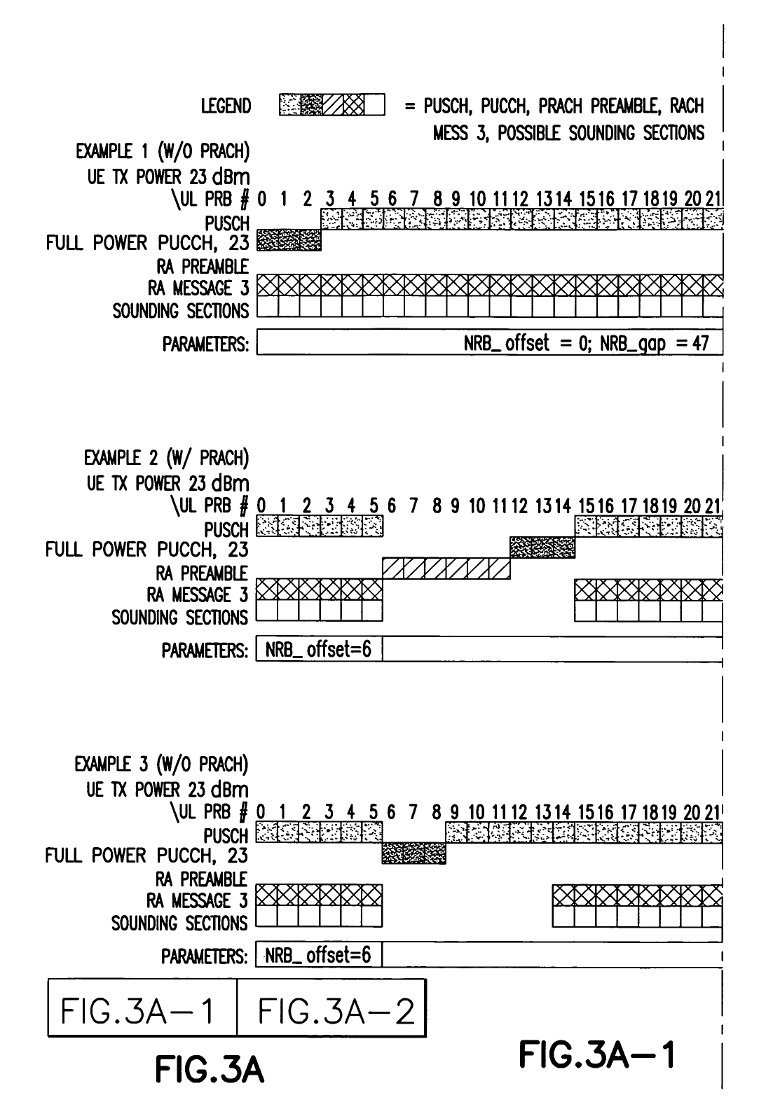

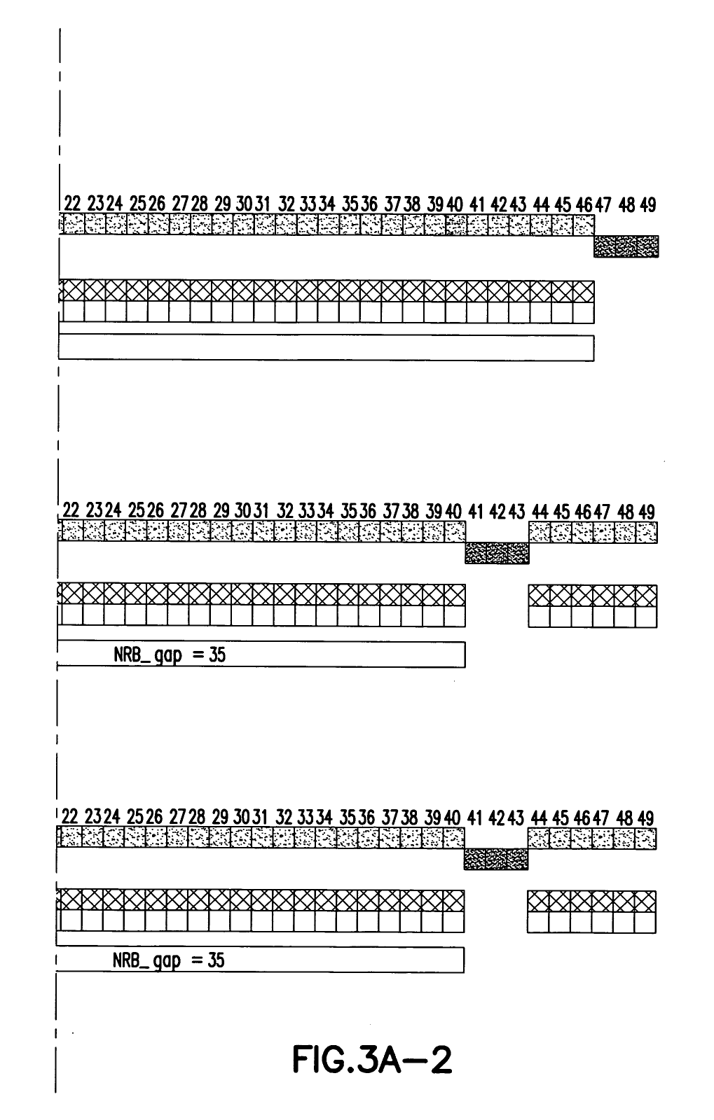

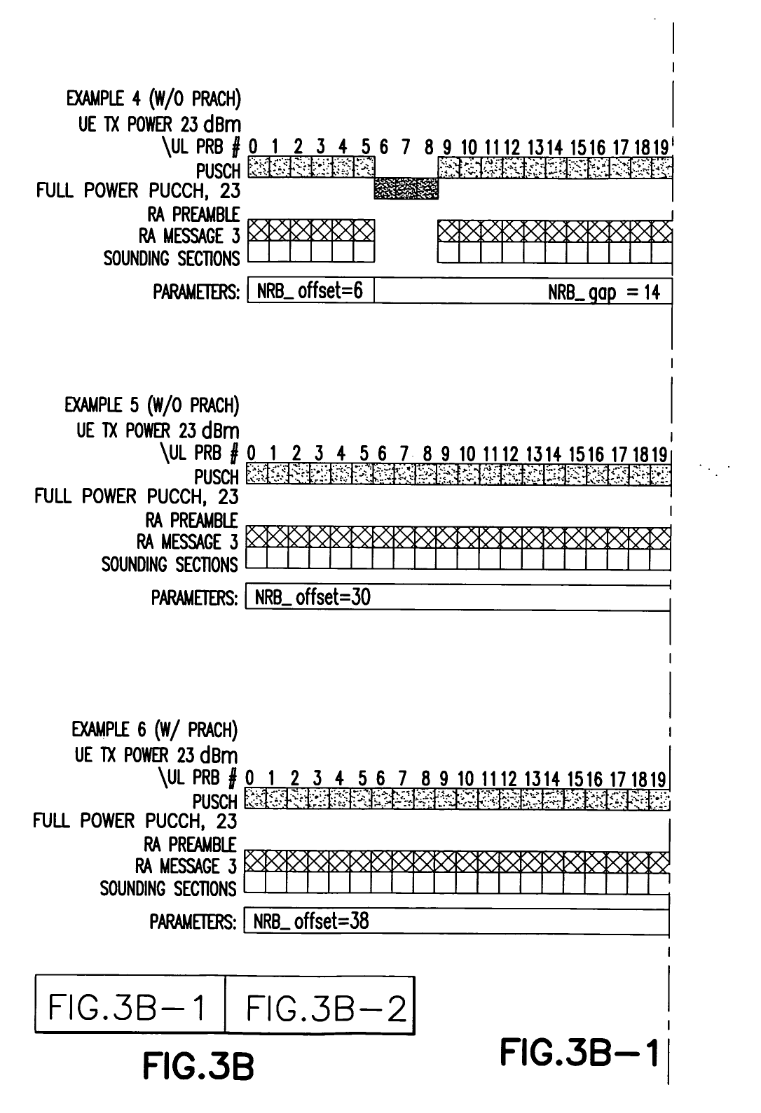

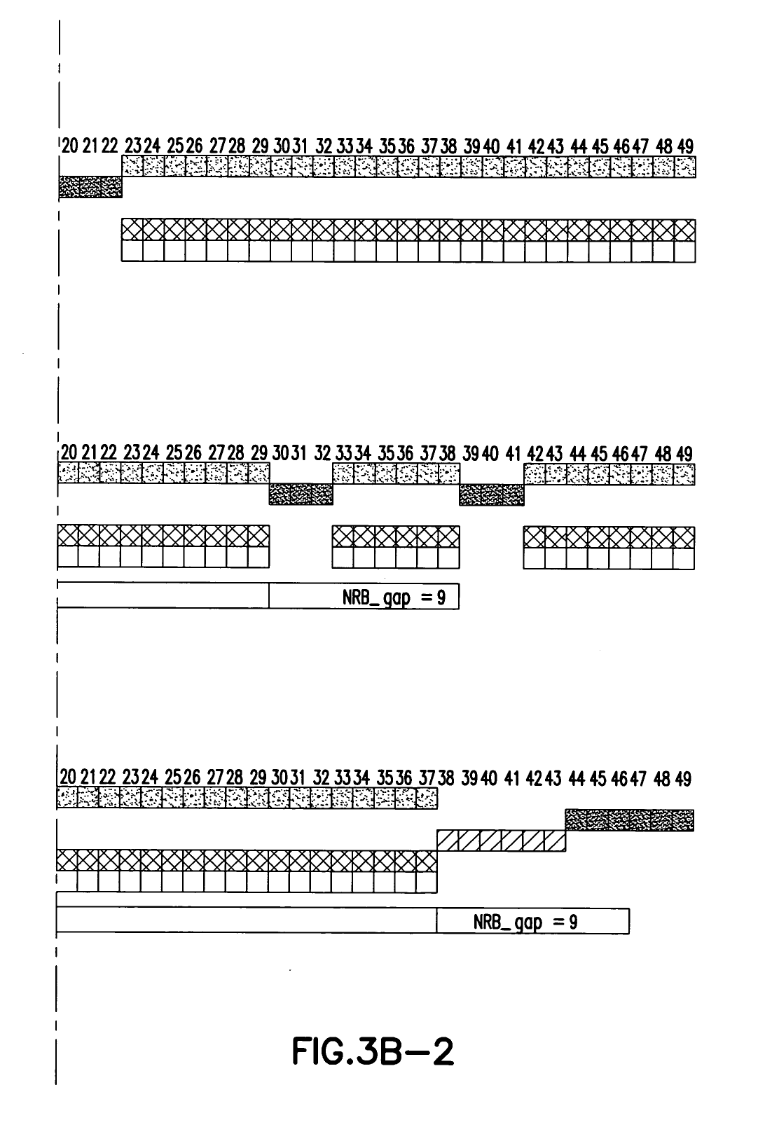

Various exemplary embodiments of this invention provide techniques to adjust the system UL bandwidth in, as one non-limiting example, LTE (release 8). The general principle is shown in FIG. 3.

More specifically, in addition to the existing PUCCH configuration using the following parameters, which are not to be read as a complete listing (see 3GPP TS 36.211 V8.3.0 (2008-05)):
N_{RB}^{PUCCH} Number of resource blocks in a slot used for PUCCH transmission (set by higher layers);
N_{RB}⁽²⁾ Bandwidth reserved for PUCCH formats 2/2a/2b, expressed in multiples of N_{sc}^{RB};

N_{cs}⁽¹⁾ Number of cyclic shifts used for PUCCH formats 1/1a/1b in a resource block with a mix of formats 1/1a/1b and 2/2a/2b; and
N_{sc}^{RB} Resource block size in the frequency domain, expressed as a number of subcarriers (=12).

(these parameters may be referred to as a “micro-configuration” of the PUCCH, including two PUCCH regions over which the signaling hops in multiples of time slots) there are also provided two additional PUCCH “macro-configuration” parameters:
NRB_offsetleft Number of resource blocks offset from the left before the “micro-configured” PUCCH resource mapping starts; and/or
NRB_gap Number of resource blocks defining the gap between the two PUCCH regions in the “micro-configured” PUCCH, more specifically the number of resource blocks from the beginning of the first to the beginning of the second PUCCH region.

In the above, “micro-configuration” parameters of the PUCCH are used in the configuration of resources used for the PUCCH in total, as well as for PUCCH formats 1/1a/1b and 2/2a/2b separately. PUCCH “macro-configuration” parameters are used in the configuration of the location of the PUCCH resources and may be used for improving PUCCH configuration in coexistence situations by implementing flexible spectrum use or interference coordination. These parameters may also impact PUSCH and PRACH configuration.

FIG. 3 shows the flexible PUCCH configuration by using the two above-mentioned macro-configuration parameters. Within the scope of the exemplary embodiments of this invention the signaled parameters can be configured in various ways, for example:

NRB_gap can be replaced by the total number of number of resource blocks occupied by PUCCH (containing PUCCH and RBs inside the PUCCH region), or

NRB_gap can be replaced by the number of resource blocks offset from the right (NRB_offsetright) before the “micro-configured” PUCCH resource mapping begins.

In all cases, the possible PUCCH starting point can be calculated from a predefined side of the spectrum. Alternatively, it is possible to calculate the PUCCH RB offset starting from the middle of the spectrum.

Furthermore, in all cases it is possible to reduce the needed signaling space by having a predefined granularity for the possible values of NRB_offset (left or right) parameter.

FIG. 3 illustrates exemplary PUCCH configuration possibilities with the addition of the foregoing macro-configuration parameter(s). The legend indicates the depictions of the PUSCH, the PUCCH, the PRACH preamble, the RACH message 3 and the possible sounding sections. Examples 1, 3, 4 and 5 show the case of a PUCCH configuration without the PRACH, while examples 2 and 6 show the case of the PUCCH configuration with the PRACH. Further, example 1 shows an exemplary value (47) for the NRB_gap macro-parameter (NRB_offsetleft=0), and examples 2 and 3 show exemplary values for both the NRB_offsetleft parameter (6 in each case) and the NRB_gap parameter (35 in each case). Example 4 show exemplary values for both the NRB_offsetleft parameter (6) and the NRB_gap parameter (14), while examples 5 and 6 show other exemplary values for the NRB_offsetleft parameter (30 and 38, respectively) and the NRB_gap parameter (9 in each case).

The utility of the flexible PUCCH resource mapping can be appreciated by a review of the examples shown in FIG. 3. Example 1 shows one macro-configuration that is neutral with respect to the existing PUCCH configuration(s) currently supported in LTE Rel-8. Example 2 shows a macro-configuration representing an existing PUCCH configuration currently supported in LTE Rel-8, and combined with PUCCH blanking as described in U.S. Provisional Patent Application No. 61/128,341. Example 3 shows an alternate TTI of example 2. Examples 4 and 5 show examples for a PUCCH macro-configuration that is not achievable with the currently specified PUCCH parameters but which may, however, be advantageously used to address certain asymmetric spectrum and coexistence issues. Example 6 shows the macro-configuration parameters being used for re-mapping the PUCCH to a single contiguous frequency band in the upper frequencies.

The flexible PUCCH resource mapping in accordance with these exemplary embodiments is not limited for use with only the six examples shown in FIG. 3. These specific, non-limiting examples illustrate that the PUCCH configuration flexibility allows for some or all of: a trade-off of frequency diversity against PUSCH data channel fragmentation, PUCCH configurations which correspond to those currently valid in LTE Rel-8 (PUCCH configurations achievable using micro-configuration parameters), PUCCH configurations tending to the “left” or to the “right” side of the spectrum in order to support asymmetric coexistence/interference issues, as well as providing a PUCCH configuration technique that does not conflict with the presence/absence of the PRACH.

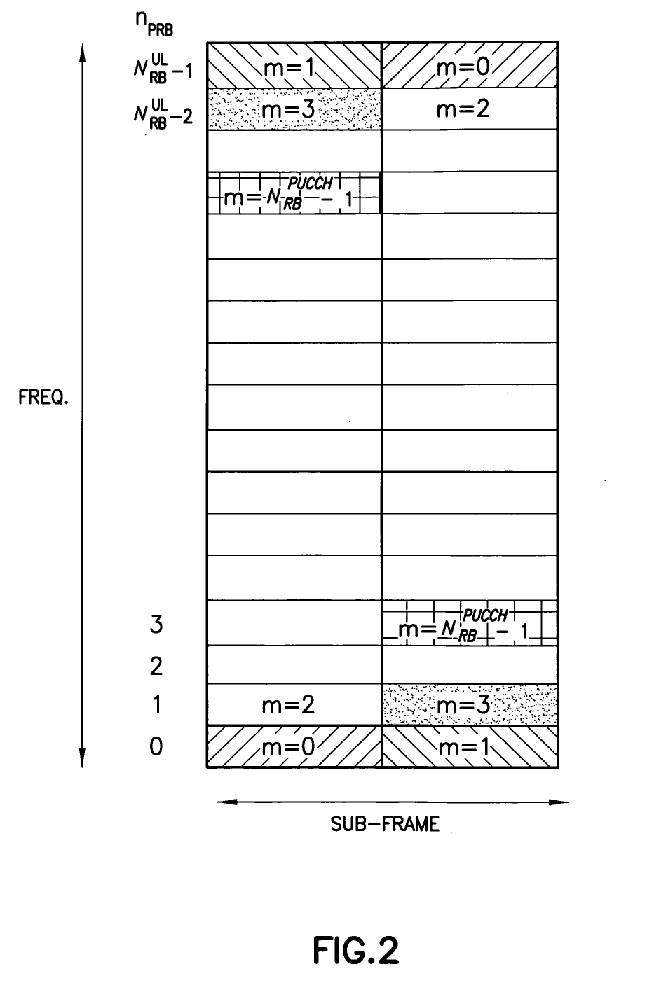

The use of various exemplary embodiments in accordance with this invention is not limited to a PUCCH with two clusters (“cluster” referring to the frequency region of PUCCH, where in LTE Rel-8, there are two PUCCH clusters due to the presence of frequency-hops) per sub-frame (as shown in FIG. 2). That is, it is possible to extend these exemplary embodiments to more than two configured PUCCH regions.

The flexible PUCCH configuration scheme may be communicated cell-wise such that any type of static ICIC and frequency reuse scheme can be supported by the PUCCH as well.

The macro-configuration parameters are preferably common/dedicated broadcast to the cell for reception by all UEs 10. For a fully flexible solution, for example 1 (2)×7 bits for configuration parameters may be used. The configuration parameters are set-up semi-statically and cell-wise.

A consistency check of the “macro-configuration” parameter(s) may be performed by the eNB 12 (or at a higher layer) to check for and avoid collisions and inconsistencies with the “micro-configuration” parameters. The hopping SRS allocation scheme may be slightly adapted such that sufficient sounding actions are still possible. Collisions between the PUCCH configuration(s) and SRS are resolved by, for example, puncturing or nulling the SRS.

The PUSCH allocations are supported by the eNB 12 scheduler in all positions not covered by the PUCCH and PRACH. Optimizations of PUSCH allocations to meet coexistence requirements may be obtained by any of the following approaches:

maximum and minimum allocation limits per RB in the system bandwidth;

including blanking the PUSCH data channel where necessary, and

interaction with power control.

These various approaches can be used to enhance the spectrum efficiency, which may be reduced by PUSCH fragmentation.

Various exemplary embodiments of this invention thus clearly enable extending the PUCCH configuration. The macro-parameters (and other parameters) may be signaled to the UE 10 via RRC signaling (both SIB and dedicated signaling). The parameter selection is made at the network side, and can be configured, e.g., via the O&M controller 18.

The use of various exemplary embodiments of this invention provides maximum flexibility for more flexible spectrum usage in the LTE and LTE-A systems, and is advantageous for deployment of the LTE UL system for arbitrary BW allocations (e.g., 8 MHz), for control of UL ACLR, for an increased amount of continuous TX BW for LTE-A UEs (SC for TX BW>20 MHz), for a more flexible arrangement of multi-cluster transmission (equally spaced clusters)->optimized CM, for increased flexibility for control signaling in the case of flexible spectrum usage (FSU), and for uplink inter-cell Interference coordination of the PUCCH resources, as several non-limiting examples.

Based on the foregoing it should be apparent that various exemplary embodiments of this invention provide a method, apparatus and computer program product(s) to provide an enhanced allocation of bandwidth for an uplink control channel, and more specifically to provide a flexible allocation of uplink system bandwidth and location(s) of an uplink control and other channels.

FIG. 6 is a logic flow diagram that illustrates the operation of a method, and a result of execution of computer program instructions, in accordance with various exemplary embodiments of this invention. At Block 6A there is a step of establishing a set of parameters comprising micro-configuration parameters and at least one macro-configuration parameter for defining a physical uplink control channel and other channel resource allocation mapping to a set of resource blocks in frequency domain; and at Block 6B there is a step of transmitting the set of parameters to at least one user equipment.

In the method and the execution of the computer program instructions as in the preceding paragraph, where macro-configuration parameters comprise at least one of a number of resource blocks offset from a beginning (left edge) of a set of resource blocks before micro-configured resource mapping begins and a number of resource blocks defining a gap between two regions in the micro-configured physical uplink control channel.

In the method and the execution of the computer program instructions as in the preceding paragraphs, where the other channels include a physical uplink shared channel and a physical random access channel.

The various blocks shown in FIG. 6 may be viewed as method steps, and/or as operations that result from operation of computer program code, and/or as a plurality of coupled logic circuit elements constructed to carry out the associated function(s).

These exemplary embodiments also provide an apparatus comprising means for establishing a set of parameters comprising micro-configuration parameters and at least one macro-configuration parameter for defining a physical uplink control channel and other channel resource allocation mapping to a set of resource blocks, and means for transmitting the set of parameters to at least one user equipment. The apparatus may be embodied as one or more integrated circuits.

A further exemplary embodiment in accordance with this invention is a method for uplink signaling. The method includes determining one or more macro-configuration parameters. The one or more macro-configuration parameters define a resource allocation mapping for a control channel. A set of parameters including one or more micro-configuration parameters and the one or more macro-configuration parameters are generated. A transmission of the set of parameters to one or more user equipment is caused to be sent.

In an additional embodiment of the method above, the resource allocation mapping includes a configuration of frequency domain resources.

In a further embodiment of any one of the methods above, the one or more macro-configuration parameters indicate one or more of: a number of resource blocks that a micro-configured physical uplink control channel resource mapping is offset; a number of resource blocks between a start of a first physical uplink control channel region and a start of a second physical uplink control channel region; and a total number of number of resource blocks occupied by the physical uplink control channel. An offset may be defined as one of: the number of resource blocks from the left; and the number of resource blocks from the right.

In an additional embodiment of any one of the methods above, an offset parameter is granular.

In a further embodiment of any one of the methods above, the method also includes: verifying that the one or more macro-configuration parameters and the one or more micro-configuration parameters are consistent.

In an additional embodiment of any one of the methods above, the method also includes causing a control channel transmission to be sent. The control channel transmission is configured in accordance with the set of parameters.

In a further embodiment of any one of the methods above, one or more macro-configuration parameters is used to indicate a frequency domain position of a physical uplink control channel

In an additional embodiment of any one of the methods above, the method also includes allocating a resource for the control channel and a shared data channel.

In a further embodiment of any one of the methods above, the transmission is a radio resource control transmission.

In an additional embodiment of any one of the methods above, the set of parameters are semi-static.

A further exemplary embodiment in accordance with this invention is an apparatus for uplink signaling. The apparatus includes at least one processor; and at least one memory including computer program code, the at least one memory and the computer program code configured to, with the at least one processor, cause the apparatus to determine one or more macro-configuration parameters. The one or more macro-configuration parameters define a resource allocation mapping for a control channel. The apparatus also generates a set of parameters including one or more micro-configuration parameters and the one or more macro-configuration parameters are included. The apparatus also causes a transmission of the set of parameters to one or more user equipment to be sent.

In an additional embodiment of the apparatus above, the resource allocation mapping includes a configuration of frequency domain resources.

In a further embodiment of any one of the apparatus above, the one or more macro-configuration parameters indicate one or more of: a number of resource blocks that a micro-configured physical uplink control channel resource mapping is offset; a number of resource blocks between a start of a first physical uplink control channel region and a start of a second physical uplink control channel region; and a total number of number of resource blocks occupied by the physical uplink control channel. An offset may be defined as one of: the number of resource blocks from the left; and the number of resource blocks from the right.

In an additional embodiment of any one of the apparatus above, an offset parameter is granular.

In a further embodiment of any one of the apparatus above, the apparatus also verifies that the one or more macro-configuration parameters and the one or more micro-configuration parameters are consistent.

In an additional embodiment of any one of the apparatus above, the apparatus also causes a control channel transmission to be sent. The control channel transmission is configured in accordance with the set of parameters.

In a further embodiment of any one of the apparatus above, one or more macro-configuration parameters is used to indicate a frequency domain position of a physical uplink control channel

In an additional embodiment of any one of the apparatus above, the apparatus also allocates a resource for the control channel and a shared data channel.

In a further embodiment of any one of the apparatus above, the transmission is a radio resource control transmission.

In an additional embodiment of any one of the apparatus above, the set of parameters are semi-static.

A further exemplary embodiment in accordance with this invention is a computer readable medium tangibly encoded with a computer program executable by a processor to perform actions for uplink signaling. The actions include determining one or more macro-configuration parameters. The one or more macro-configuration parameters define a resource allocation mapping for a control channel. A set of parameters including one or more micro-configuration parameters and the one or more macro-configuration parameters are generated. A transmission of the set of parameters to one or more user equipment is caused to be sent.

In an additional embodiment of the computer readable medium above, the resource allocation mapping includes a configuration of frequency domain resources.

In a further embodiment of any one of the computer readable media above, the one or more macro-configuration parameters indicate one or more of: a number of resource blocks that a micro-configured physical uplink control channel resource mapping is offset; a number of resource blocks between a start of a first physical uplink control channel region and a start of a second physical uplink control channel region; and a total number of number of resource blocks occupied by the physical uplink control channel. An offset may be defined as one of: the number of resource blocks from the left; and the number of resource blocks from the right.

In an additional embodiment of any one of the computer readable media above, an offset parameter is granular.

In a further embodiment of any one of the computer readable media above, the actions also include verifying that the one or more macro-configuration parameters and the one or more micro-configuration parameters are consistent.

In an additional embodiment of any one of the computer readable media above, the actions also include causing a control channel transmission to be sent. The control channel transmission is configured in accordance with the set of parameters.

In a further embodiment of any one of the computer readable media above, one or more macro-configuration parameters is used to indicate a frequency domain position of a physical uplink control channel

In an additional embodiment of any one of the computer readable media above, the actions also include allocating a resource for the control channel and a shared data channel.

In a further embodiment of any one of the computer readable media above, the transmission is a radio resource control transmission.

In an additional embodiment of any one of the computer readable media above, the set of parameters are semi-static.

A further exemplary embodiment in accordance with this invention is an apparatus for uplink signaling. The apparatus includes means for determining one or more macro-configuration parameters. The one or more macro-configuration parameters define a resource allocation mapping for a control channel. Means for generating a set of parameters including one or more micro-configuration parameters and the one or more macro-configuration parameters are included. The apparatus also includes means for causing a transmission of the set of parameters to one or more user equipment to be sent.

In an additional embodiment of the apparatus above, the resource allocation mapping includes a configuration of frequency domain resources.

In a further embodiment of any one of the apparatus above, the one or more macro-configuration parameters indicate one or more of: a number of resource blocks that a micro-configured physical uplink control channel resource mapping is offset; a number of resource blocks between a start of a first physical uplink control channel region and a start of a second physical uplink control channel region; and a total number of number of resource blocks occupied by the physical uplink control channel. An offset may be defined as one of: the number of resource blocks from the left; and the number of resource blocks from the right.

In an additional embodiment of any one of the apparatus above, an offset parameter is granular.

In a further embodiment of any one of the apparatus above, the apparatus also includes means for verifying that the one or more macro-configuration parameters and the one or more micro-configuration parameters are consistent.

In an additional embodiment of any one of the apparatus above, the apparatus also includes means for causing a control channel transmission to be sent. The control channel transmission is configured in accordance with the set of parameters.

In a further embodiment of any one of the apparatus above, one or more macro-configuration parameters is used to indicate a frequency domain position of a physical uplink control channel

In an additional embodiment of any one of the apparatus above, the apparatus also includes means for allocating a resource for the control channel and a shared data channel.

In a further embodiment of any one of the apparatus above, the transmission is a radio resource control transmission.

In an additional embodiment of any one of the apparatus above, the set of parameters are semi-static.

In a further embodiment of any one of the apparatus above, the means for determining is a processor, the means for generating is a processor and the means for causing a transmission is a processor.

An additional exemplary embodiment in accordance with this invention is a method for uplink signaling. The method includes receiving a set of parameters comprising micro-configuration parameters and at least one macro-configuration parameter. The at least one macro-configuration parameter defines a physical uplink control channel and channel resource allocation mapping for a set of resource blocks. A transmission is received. The transmission is configured in accordance with the set of parameters.

A further exemplary embodiment in accordance with this invention is an apparatus for uplink signaling. The apparatus includes at least one processor; and at least one memory including computer program code, the at least one memory and the computer program code configured to, with the at least one processor, cause the apparatus to receive a set of parameters comprising micro-configuration parameters and at least one macro-configuration parameter. The at least one macro-configuration parameter defines a physical uplink control channel and channel resource allocation mapping for a set of resource blocks. The apparatus also receives a transmission configured in accordance with the set of parameters.

An additional exemplary embodiment in accordance with this invention is a computer readable medium tangibly encoded with a computer program executable by a processor to perform actions for uplink signaling. The actions include receiving a set of parameters comprising micro-configuration parameters and at least one macro-configuration parameter. The at least one macro-configuration parameter defines a physical uplink control channel and channel resource allocation mapping for a set of resource blocks. A transmission configured in accordance with the set of parameters is received.

A further exemplary embodiment in accordance with this invention is an apparatus for uplink signaling. The apparatus includes means for receiving a set of parameters comprising micro-configuration parameters and at least one macro-configuration parameter. The at least one macro-configuration parameter defines a physical uplink control channel and channel resource allocation mapping for a set of resource blocks. Means for receiving a transmission configured in accordance with the set of parameters are included.

In a further embodiment of any one of the apparatus above, the means for receiving is a receiver.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of various exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. As such, it should be appreciated that at least some aspects of various exemplary embodiments of the inventions may be practiced in various components such as integrated circuit chips and modules.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

For example, while the exemplary embodiments have been described above in the context of the E-UTRAN (UTRAN-LTE) system and the LTE-Advanced system, it should be appreciated that the exemplary embodiments of this invention are not limited for use with only these particular types of wireless communication systems, and that they may be used to advantage in other wireless communication systems.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, the various names used for the described parameters (e.g., RB_offsetleft, RB_gap, etc.) are not intended to be limiting in any respect, as these parameters may be identified by any suitable names. Further, the various names assigned to different channels (e.g., PUCCH, PUSCH, PRACH, etc.) are not intended to be limiting in any respect, as these various channels may be identified by any suitable names.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
determining at least one macro-configuration parameter, where the at least one macro-configuration parameter defines a resource allocation mapping for a control channel;
generating a set of parameters comprising at least one micro-configuration parameter and the at least one macro-configuration parameter; and
causing a transmission of the set of parameters to at least one user equipment.

2. The method of claim 1, where the resource allocation mapping comprises a configuration of frequency domain resources.

3. The method of claim 1, where the at least one macro-configuration parameter indicates at least one of: a number of resource blocks that a micro-configured physical uplink control channel resource mapping is offset; a number of resource blocks between a start of a first physical uplink control channel region and a start of a second physical uplink control channel region; and a total number of number of resource blocks occupied by the physical uplink control channel.

4. The method of claim 3, where an offset is defined as one of: the number of resource blocks from the left; and the number of resource blocks from the right.

5. The method of claim 3, where an offset parameter is granular.

6. The method of claim 1, further comprising: verifying that the at least one macro-configuration parameter and the at least one micro-configuration parameter are consistent.

7. The method of claim 1, further comprising: causing a control channel transmission to be sent, where the control channel transmission is configured in accordance with the set of parameters.

8. The method of claim 1, where at least one macro-configuration parameter is used to indicate a frequency domain position of a physical uplink control channel.

9. The method of claim 1, further comprising: allocating a resource for the control channel and a shared data channel.

10. The method of claim 1, where the transmission is a radio resource control transmission.

11. An apparatus, comprising: at least one processor; and at least one memory including computer program code, the at least one memory and the computer program code configured to, with the at least one processor, cause the apparatus to perform at least the following:
to determine at least one macro-configuration parameter, where the at least one macro-configuration parameter defines a resource allocation mapping for a control channel;
to generate a set of parameters comprising at least one micro-configuration parameter and the at least one macro-configuration parameter; and
to cause a transmission of the set of parameters to at least one user equipment.

12. The apparatus of claim 11, where the resource allocation mapping comprises a configuration of frequency domain resources.

13. The apparatus of claim 11, where the at least one memory and the computer program code are further configured to, with the at least one processor, cause the apparatus to: verify that the at least one macro-configuration parameter and the at least one micro-configuration parameter are consistent.

14. (canceled)

15. The apparatus of claim 11, where at least one macro-configuration parameter is used to indicate a frequency domain position of a physical uplink control channel

16. A computer readable medium tangibly encoded with a computer program executable by a processor to perform actions comprising:
determining at least one macro-configuration parameter, where the at least one macro-configuration parameter defines a resource allocation mapping for a control channel;
generating a set of parameters comprising at least one micro-configuration parameter and the at least one macro-configuration parameter; and
causing a transmission of the set of parameters to at least one user equipment.

17. The computer readable medium of claim 16, where the resource allocation mapping comprises a configuration of frequency domain resources.

18. The computer readable medium of claim 16, further comprising: verifying that the at least one macro-configuration parameter and the at least one micro-configuration parameter are consistent.

19. (canceled)

20. The computer readable medium of claim 16, where at least one macro-configuration parameter is used to indicate a frequency domain position of a physical uplink control channel

21. An apparatus, comprising:
means for determining at least one macro-configuration parameter, where the at least one macro-configuration parameter defines a resource allocation mapping for a control channel;
means for generating a set of parameters comprising at least one micro-configuration parameter and the at least one macro-configuration parameter; and
means for causing a transmission of the set of parameters to at least one user equipment.

22. The apparatus of claim 21, where the resource allocation mapping comprises a configuration of frequency domain resources.

23.-25. (canceled)
